(19) United States
(12) Patent Application Publication
(10) Pub. No.: US 2008/0201154 A1
(43) Pub. Date: Aug. 21, 2008

(54) SYSTEM AND METHOD FOR CONTINUOUS PROCESS IMPROVEMENT

(76) Inventor: Skipp Anne Haynes Williamson, Toorak (AU)

Correspondence Address: CESARI AND MCKENNA, LLP, 88 BLACK FALCON AVENUE, BOSTON, MA, 02210, US

(21) Appl. No.: 11/675,388

(22) Filed: Feb. 15, 2007

(51) Int. Cl. G06Q 99/00

(52) U.S. Cl. 705/1

(57) ABSTRACT

A system and method for continuously handling ideas and incorporating them into a business process to improve the business and the business processes are disclosed. The system and method includes pipelining of ideas, organizing the management line personnel for driving the ideas into the business process and organizing, coaching and training the personnel that are implementing the invention into as a sustainable, continuous process

### FIELD OF THE INVENTION

The present invention relates to systems and methods for identifying and implementing improvements in production processes for materials, goods and services and, more particularly, to systems and methods for continuously identifying, implementing and embedding improvements in processes in specific business enterprises.

### BACKGROUND OF THE INVENTION

Business enterprises (firms) in all economic sectors which produce and sell goods and services through standard, repeatable sales, production, or service delivery processes are under constant economic pressure to increase the efficiency of those processes. Efficiency and performance are used interchangeably herein. This drive for this improved efficiency has been made more urgent by the financial demands of the capital markets and global competition. The proper measure of efficiency for any business process is ultimately measured in cash inputs and outputs per unit as identified with the specific business. Business enterprises must be constantly achieving higher throughput, lower defect/error rates, and lower costs relative to past performance. This continuous improvement cycle can be in part a function of the design of the goods or services being produced, the design and configuration of the processes to produce them, but is mainly driven and executed by the “line management,” those who run these processes day to day as distinct from upper level management, outside consultants, and the like. At each work and management level and at each step in a process, in almost all cases, there are many discrete and implementable changes that can potentially lead to improved performance. New technologies and methods continuously expand these improvement opportunities. In practice, however, most business enterprises fail to achieve sustainable and continuous improvements in the performance of their operations relative to what could be achieved given the available tools known in the art.

This failure stems from the limitations and disadvantages of the conventional and near universal approaches to performance improvement practiced by firms today. This is not to say that these conventional approaches are entirely ineffective—far from it—but that they may be substantially improved.

One disadvantage of the conventional methods, including the well known in the art Six Sigma, Lean Manufacturing, TQM (Total Quality Management) and business process reengineering, is that process improvement is treated as a series of projects executed by teams. These projects have a beginning—usually in reaction to a financial or quality problem—a middle where a great deal of analysis and concepts for improvement are generated, and an end, where the identified improvements are handed-off for implementation. In fact, large organizations generate far more concepts/opportunities for improvement than line management can possibly implement. Implementation is difficult, rarely gets done, often does not get sufficiently well managed to capture all the value and even more rarely is sustained at the line management level.

Another disadvantage of conventional approaches is that they focus on concepts for improvement based on analysis rather than concrete ideas-things that line management can actually make happen, measure and track against expected results. Herein “concepts” relates to abstractions that cannot be directly put into effect, “concrete ideas,” or “ideas” represent specific, new or altered process steps or procedures, or the like, that will manifest, inter alia, an improvement. Moreover, there is a natural limit to how much change can be absorbed at the line level, so rigorous prioritization of ideas based on hard cash potential is essential if anything is to actually get done. However, conventional approaches focus on up front analysis and concept generation rather than implementation of sustainable process improvements. This largely reflects the far greater difficulty of the latter, but also the natural analytical biases of the management consulting profession as compared to the line management.

Yet another disadvantage of conventional approaches of the prior art, stems directly from its origins in management consulting. This goes all the way to Frederick Taylor's time and motion studies. The notion that a third party “efficiency expert” can add value by observing and measuring processes and suggesting improvements to top management is central to the current practices of many leading business consulting firms. Although superficially the system and method of the current invention uses concepts drawn from management consulting, it entirely rejects key concepts and practices of consulting, including its project work structure, its over-heavy focus on analytics, its top management perspective, and its production of reports, recommendations and programs as products.

### SUMMARY OF THE INVENTION

The present invention addresses the disadvantages and limitations of the prior art by providing a system and method for embedding continuous improvements in processes within a business enterprise at the line management level, thereby obviating the need for external management consultants and internal project teams going forward. In one embodiment the present invention provides, as described below, systems and processes for pipelining ideas, wiring of organizations, and coaching/skills that advantageously embed continuous performance improvements in a business. The present invention provides tracking of results at the level of cash generation and sustainable lock in (on the ideas side) along with tracking of ideas and KPIs through an organization's systems or manually if needs be. In an illustrative embodiment, the invention comprises a standard set of software templates, meeting scripts, skill assessments, and output tables that allow line management, with some initial coaching to continuously improve processes and results in their day to day management activity. The present invention allows the results of discrete, specific line level idea implementations to be rolled up to the top, upper or general management for decision making and, concurrently, driven down to work team levels for motivation and incentive purposes. The present invention includes tools (value driver trees, prioritization frameworks, target setting, cascaded accountabilities, risk assessment, validation processes, tracking (of ideas and KPIs), variance reporting, operating procedures, and wiring diagnostics.

The invention is based at least in part on the concept (defined as above—not something that can be directly implemented) that performance improvement is a discrete and definable management discipline that can be advantageously applied to any business process, such as production, sales, customer service in virtually any industry. Like other disciplines, such as accounting or materials engineering, its application is standard, repeatable, auditable and correctly embedded and implemented into any business process. Indeed, a preferred implementation of the present invention as a standard method of virtually universal application rather than a general approach to managing “projects” is important to the invention's effectiveness. The present invention may be embodied in repeatable steps embedded in tools and software.

The present invention may be used advantageously for creating a high performing business, together with how to manage that business. Specifically, the wiring and coaching train managers how to manage a business for high performance. The present invention introduces new ideas and trains and equips an organization's personnel to manage people and tasks so that the business gets better in all aspects because people behave differently and take accountability differently.

An embodiment of the invention provides for a system and series of steps that are divided into three clusters that are executed concurrently, (FIG. 1).

The ideas pipeline 2 is a disciplined prioritization process that drives all potential ideas through a series of decision points, filters or gates to select the high value/high chance of success ideas. The ideas pipeline systematically generates and delivers the cash on the highest priority levels and ensures that they are sustainable.

Wiring 4 is defined herein as systems, processes, procedures, accountabilities, skills, reviews, performance metrics and incentives and visible leadership of the organization that combine together to determine how an organization performs. The wiring process is the process which systematically audits or diagnoses the current wiring in a business and works with the management team to identify which elements to alter and how to create wiring which supports and drives the desired strategy and results of a business [i.e., if you want to be high performing and deliver results you wire yourself up differently as an organization than if you want to be relaxed, easy going and middle of the pack]. The process systematically audits current wiring, identifies and implements improvements so the organization will be aligned and wired to maintain high performance and support a continuous flow of improvements that are each sustained. This approach becomes “part of the job” for the organization's personnel. The approach involves, typically, standard diagnostics, prescriptive views on what the various elements of an improvement should look like (or types of solutions), systematic planning, design and implementation, coaching and management of changes to the wiring and other tools and methods to ensure sustainability of the wiring once in place. Note that extensive skill building is needed to make changes in wiring, e.g., if people don't come from a culture of accountability, they aren't going to suddenly switch into one overnight without extensive coaching and skill building. The operating strategy of each area and KPI's are systematically reviewed with a goal of finding the best method to deliver on that strategy, deriving modifications if needed to operating procedures and process controls to effect that revised strategy. The reviews include accountabilities, incentives and role clarity within the organization and modifications thereof to ensure they align with the revised operating strategy in each area, department, and/or site. The approach helps develop/improve the performance management system to ensure that each layer in the organization is aligned and motivated to deliver on the KPIs (Key Performance Indicators) y delivering the operating disciplines. The above combines, with templates for regular performance reviews at each layer in the organization, processes for identifying and managing variances in results, setting monthly stretch targets at each layer in the businesses, and ongoing auditing of the wiring processes for continuously improving performance. Finally processes are put in place to systematically capture the benefits of visible leadership by ensuring that managers are systematically meeting their people and covering the key elements needed to direct and inspire their people.

Leadership and Coaching 6 [skills transfer] is a combination of formal training where skills and competencies are built to ensure that the ideas pipeline and the businesses' wiring are driven and sustained. Day to day coaching ensures that a sustainable process of continuous improvement and managing for high performance becomes embedded in line management and in their reports and they have the competencies to deliver this well. Coaching is performed at the line management level and required skills drive the training. Higher education levels may be required and/or acquired for particular skills. Transfer of skills and the assessment of competency levels is managed through the skills matrix as a tool to track training attendance and competency levels of each individual concerned.

In practice, the invention provides sustainable performance improvement if all three clusters are executed in a coordinated and standard fashion. Each cluster embodies templates, software, and scripts that ensure and enforce standardization and discipline in carrying out the embodiments. A preferred embodiment of the invention provides a repeatable, sustainable and self-reinforcing performance improvement process, not in any individual tool or known method. Many of these, like value driver trees or pareto analysis are well known and widely used in management consulting. Making these tools and methods systematic, standard and embedded in line management is an objective of the present invention.

It will be appreciated by those skilled in the art that although the following Detailed Description will proceed with reference being made to illustrative embodiments, the drawings, and methods of use, the present invention is not intended to be limited to these embodiments and methods of use. Rather, the present invention is of broad scope and is intended to be defined as only set forth in the accompanying claims.

### BRIEF DESCRIPTION OF THE DRAWINGS

The invention description below refers to the accompanying drawings, of which:

FIG. 1 is a pictorial flow diagram incorporating the present invention;

FIGS. 2, 3 are flow diagrams with tasks illustrating portions of the ideas pipeline;

FIG. 4 is an example of prioritized and analyzed areas for improvement for an aluminum extrusion process;

FIG. 5 is a tree diagram illustrating root causes for the dents of FIG. 4;

FIG. 6 is a value-ease diagram;

FIG. 7 is check list for an idea that is locked in (fully implemented on a sustainable basis);

FIG. 8 contains lists illustrating the operation of software that captures and tracks actions and KPI's associated with each idea;

FIG. 9 is a pictorial hierarchical pyramid diagram illustrating the wiring within a business enterprise;

FIG. 10 is a RAR (Result Action Review) chart;

FIG. 11 is a KPI tracking form;

FIG. 12 is an illustration of an overall culture illustrating the present invention;

FIG. 13 is an illustration of coaching and transferring of skills;

FIG. 14A is a matrix chart of skills training;

FIG. 14B is a skills template; and

FIG. 15 is a matrix of a training record.

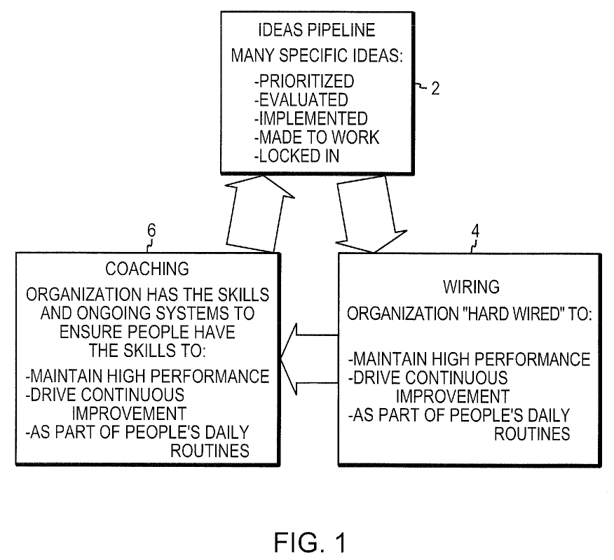

### DETAILED DESCRIPTION OF AN ILLUSTRATIVE EMBODIMENT

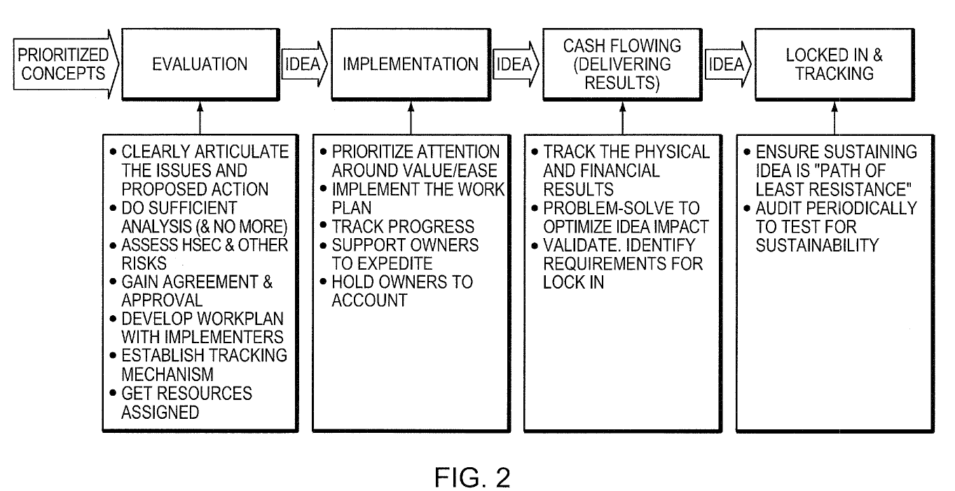

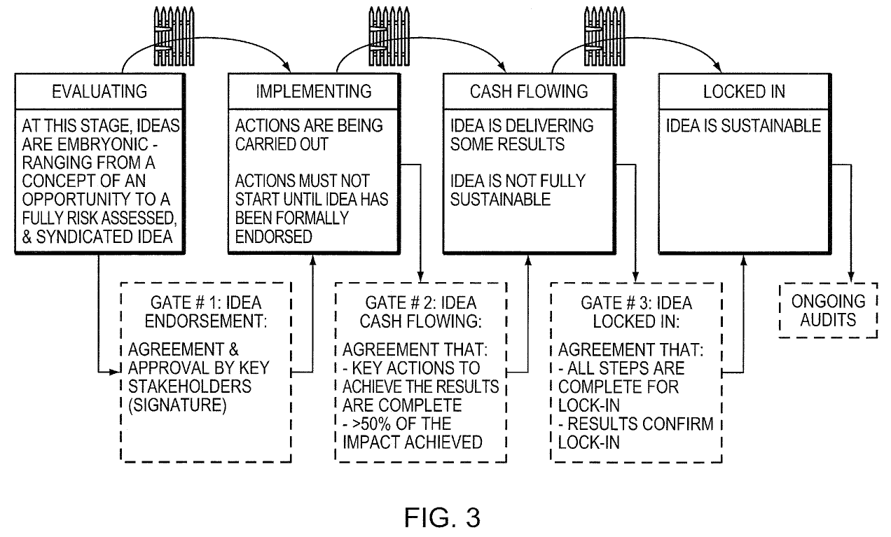

Idea Pipeline Schematic (FIGS. 2, 3) lay out the full linear process by which a performance improvement “idea” is identified, prioritized, endorsed by stockholders, implemented, validated (to ensure it's actually working), and eventually locked in as a sustainable and measurable/auditable process step that is accountable to line management. Each step or stage in the schematics is embodied in a specific template or form (identified by number).

FIG. 2 diagrams an explicit, continuous approach to managing the ideas pipeline. The initial concepts are prioritized and evaluated by: making the issues and proposed actions clear; analyzing the value of the idea, assessing the risks, gaining agreement and approval, developing a work plan and tracking mechanism and assigning resources. The idea is implemented with detail to the value of the idea and its ease of implementing. Owners of the idea are identified as accountable for the idea and implementation progress is tracked. The physical and financial results are tracked, any problems are addressed and solved so that the impact of the idea is optimum, and the idea is validated as working and delivering the desired results and then validated as “locked in.” Here “locked in” refers to a permanent idea implementation into the business processes. The last issue in the idea pipeline is to ensure the idea is sustained through periodic auditing to ensure the results and processes remain in place. FIG. 3 shows the same steps as in FIG. 2, except necessary gating or approvals are illustrated between each of the evaluating, implementing, cash flowing and locked in steps in the process.

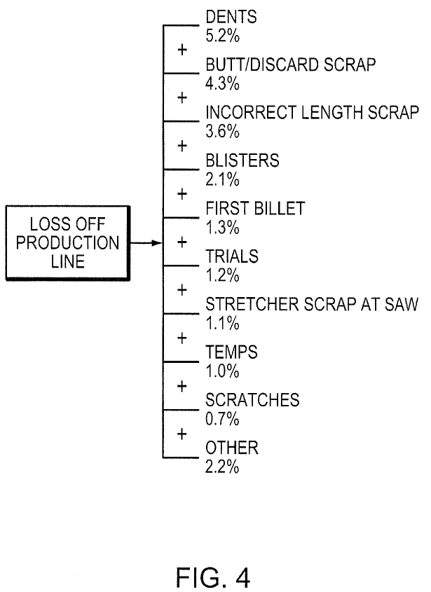

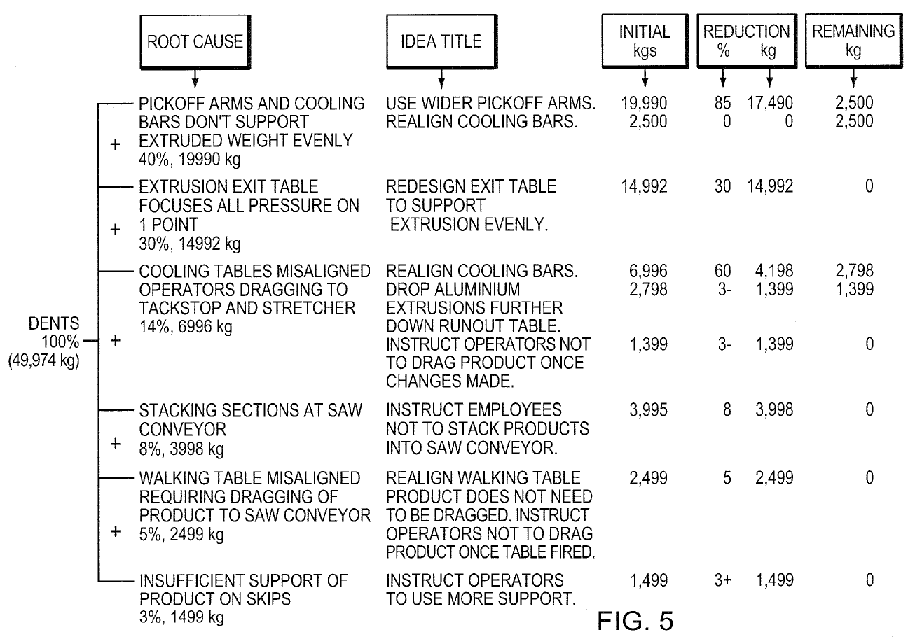

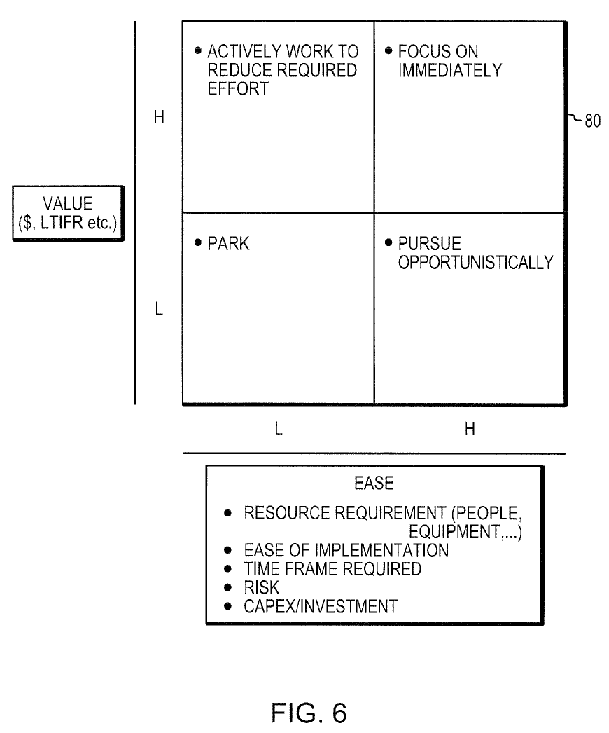

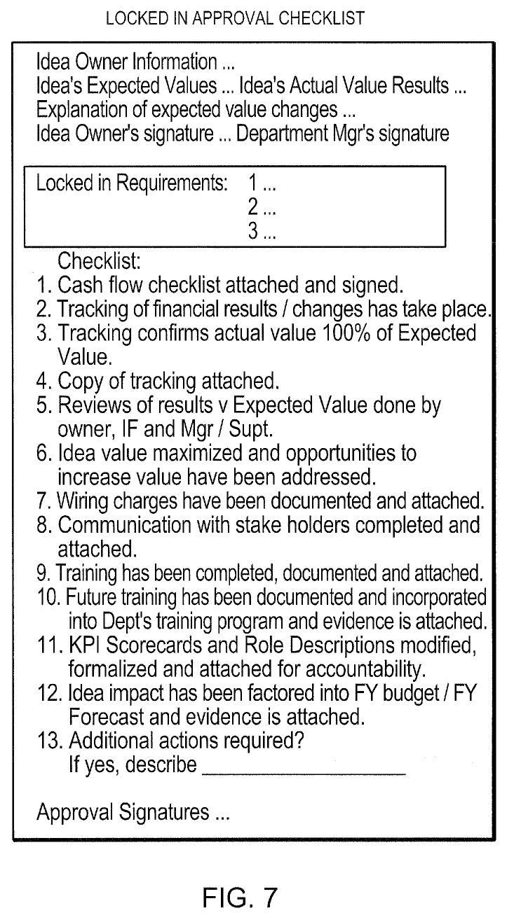

FIG. 2 prioritizes the initial concepts via a structured process throughout an engagement to ensure the “right” ideas are being worked on. The process focuses attention to the value and ease of the idea. For example. a zinc processing operation may be considered. Value driver trees are developed for each area of the zinc processing. From here the highest priority areas are identified as candidates for working on (other areas may include: safety, smelting, casting, etc.) along with areas NOT to work on and these priority areas are supported with additional resources. Within any of these areas detailed value driver trees are constructed to identify the highest value areas for improvement in the area and structured Idea Generation Sessions are run in a prioritized fashion around each element of the driver tree. Out of each Idea Generation Session a number of ideas are typically generated and then are prioritized using a Value:Ease matrix to identify the highest value ideas and those which are easiest to implement. This results in only a few (1-2) of the ideas being implemented initially. The list of ideas is revisited at a later date when they move to the top of the list of possible priority ideas.
1. Diagnostic and prioritization process flows and financial analysis sheets. FIG. 4 illustrates the process of capturing and structuring the data to identify the drivers of losses of material due to quality problems (in this case in an aluminum extrusion plant where “dents” are identified as the highest priority issue. FIG. 5 illustrates the root causes of the dents. In this case the pickoff arms and cooling bars account for 40% of the dents.
2. Value Ease Matrix FIG. 6 illustrates the trade off between the value of the potential result along the vertical axis of an idea versus the ease along the horizontal axis with which it becomes a locked in idea. The upper right hand quadrant 80 identifies ideas to focus on immediately.
3. An Idea Form and sign-off process
form records the situation, opportunity, risk and the signatures of the “stakeholders.” The stakeholders or owners are those responsible for the implementation of the idea and those who need to support the idea for implementation to work or be sustained and must sign off on the idea. Typically such a form would include the owner portion of the company where the idea is to be implemented and the projected value if implemented. The form would define the problem situation, the opportunity and the actions to be taken. The risks and how the risks are to be managed are specified, and the stakeholders agree and sign off on the form.
4. An Idea tracking and implementation form
defines tracking metrics, and implementation plan and personnel responsible for a detailed implementation plan. For example, the business area affected and how that area is measured are defined. The unit of measure, time, and who is responsible and how often the KPI is to be reviewed are specified. The details of the implementation plan may include material specifications and costs, suitability of the materials, purchase orders timely generated, delivery dates confirmed, maintenance work needed and by when, coordination with production, training, support and agreed changes. People responsible and time deadlines are typically specified in this form.
5. A Idea key performance indicators sheet illustrates the tracking of an idea that is reviewed with the idea owners. Information on KPI's provide the basis for validating ideas with respect to cash flow and locked-in status. Detailed data on prospective improvements in KPI's by all ideas and time projections for those improvements are recorded in these sheets.
6. An Idea quality control check list is completed for approval by managers. The basic idea, the root cause of risks and management thereof, the dollar value, the value/ease determination, the metrics used to track, implementation milestones, copies of support documentation and all required signatures may be on the quality control check list.
7. Idea Health, Safety Compliance check list is a health and safety compliance checklist that is completed for approval by managers. Areas defined in such a check list may include: hazardous areas, actions being taken addressing risks, interactive risks addressed and responsibilities and activities taken to mitigate the risks, are engineering and other applicable standards and specifications being met, health, noise, heat, radiation and lighting hazards addressed, electrical and mechanical hazards addressed, radiation, ergonomics issues addressed, chemical, waste materials, environmental, pollution and monitoring issues, any effluent issues and government regulations, permits, emergencies scenarios, and effects on the local community. All such and other relevant issues may be included in such a check list.
8. An Idea Implementation Approval check list is to be completed for approval by managers Here all the earlier relevant information and check lists may be accumulated such that the idea owner can agree to implement the idea in the owners business area. The signatory agree that he is responsible to successfully implement the idea. He agrees that the necessary support is available or is requested. He agrees to be responsible for the cash flow and for locking in the idea.
9. An Idea cash flowing checklist that is to be completed for approval by the Idea Owner, Area Department manager and person assigned to review validation of ideas (typically a Chief Accountant for the Area). This list reviews the metrics over time, affirms recent results, identifies risks and affirms their management, updates progress and identifies actions to be taken, and affirms the lock-in requirements and prospective lock-in date.
10. FIG. 7 illustrates a Locked In (i.e., fully implemented on sustainable basis) approval check list. FIG. 7 is completed for approval by managers and is representative of the form of the above discussed check lists. The steps described above are managed and monitored using a custom software suite which tracts actions and captures key information on each idea in a standard format.

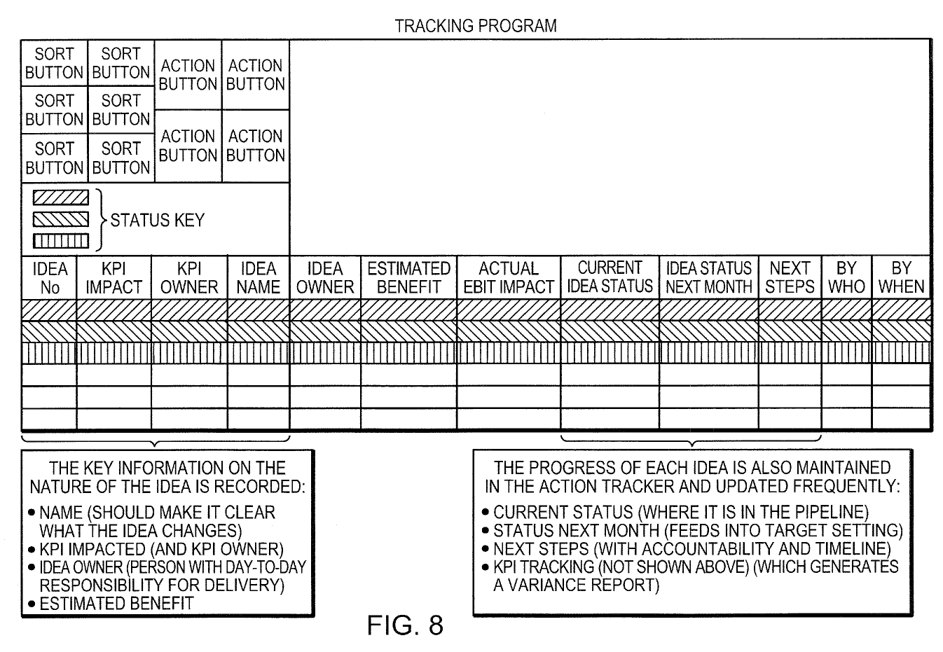

FIG. 8 is a form that tracks actions to maintain critical information on ideas. This form allows the actions and key performance indicators associated with each idea to be tracked continuously against expected results and reviewed or modified as appropriate. Other forms track costs, pipeline status, and compares the top five ideas as they progress through the pipeline, another form tracks cash versus target. The tracker of actions allows management to track a 90 day rolling average of the value delivered by each idea and the sum of all ideas to see which are delivering value. This lays a foundation for regular management reviews, reprioritization, target setting and constant, routine variance tracking.

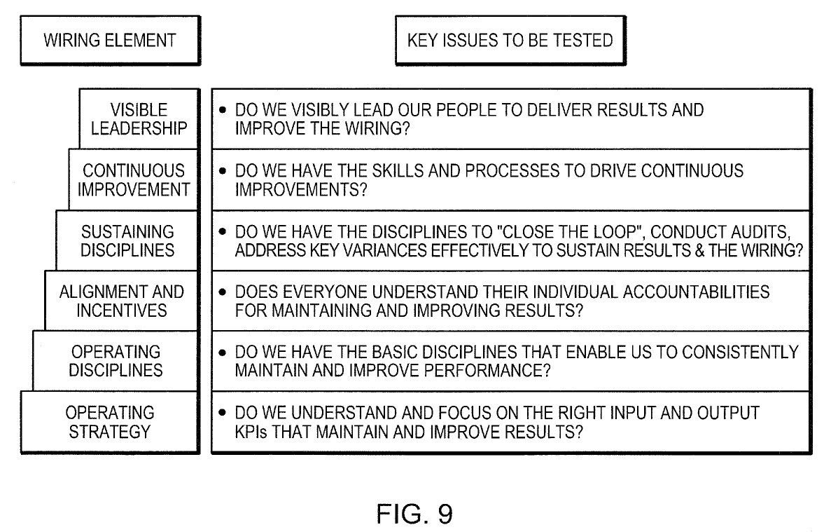

Organizational Wiring Schematic lays out a framework for looking at how an organization is wired up (systems, process, procedures, accountabilities, and skills combine to determine how an organization behaves and will behave). The wiring process is a parallel process through which the business organization is managed with the systems, processes, role identification, performance metrics, reviews, skills and incentive structures required to sustain high performance and drive continuous improvement. (FIG. 9)

The wiring process as illustrated in the pyramid schematic rests on very hard elements like an operating strategy based on key performance indicators (KPI's) that can be measured and monitored. However, upon this foundation lay a series of more difficult to quantify elements, each critical to success

Operating disciplines, define management disciplines essential to maintain and improve performance Some such disciplines are generic but others are very specific, e.g., situation dependent Standard Operating Procedures (SOP's) for each stage in an operation or Statistical Process Controls (SPCs) for a specific stage in the operation. To deliver the operating strategy one must either get people or machines to deliver a repeatable process. This is done either thru SOP's or SPC.

Alignment and Incentives, assuring that individual accountability for results is firmly established, well understood, and reinforced by compensation and rewards and systematic processes to review, develop and promote/exit the talent.

Sustaining disciplines, the management disciplines required to constantly audit performance, address key variances and otherwise sustain results and the overall effectiveness of the wiring in the pyramid underneath.

Continuous Improvement disciplines, a specific set of skills and processes to constantly demand the highest achievable improvement goals and learn from operating experience.

Visible Leadership, observant, demanding and recognizing success and initiative on the part of line managers and team leaders. The key tasks of leadership in the continuous change process are: focusing the organization on delivering results on the priority KPIs, ensuring that the organizational wiring is understood and managed, taking decisions between competing priorities and calls for resources and above all maintaining commitment and momentum.

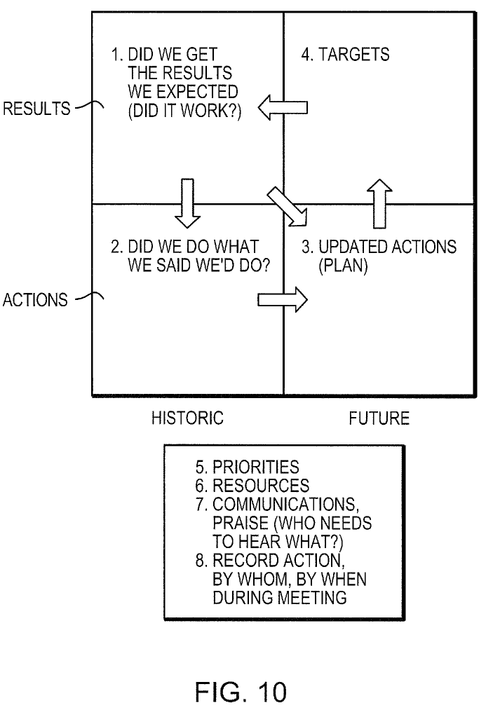

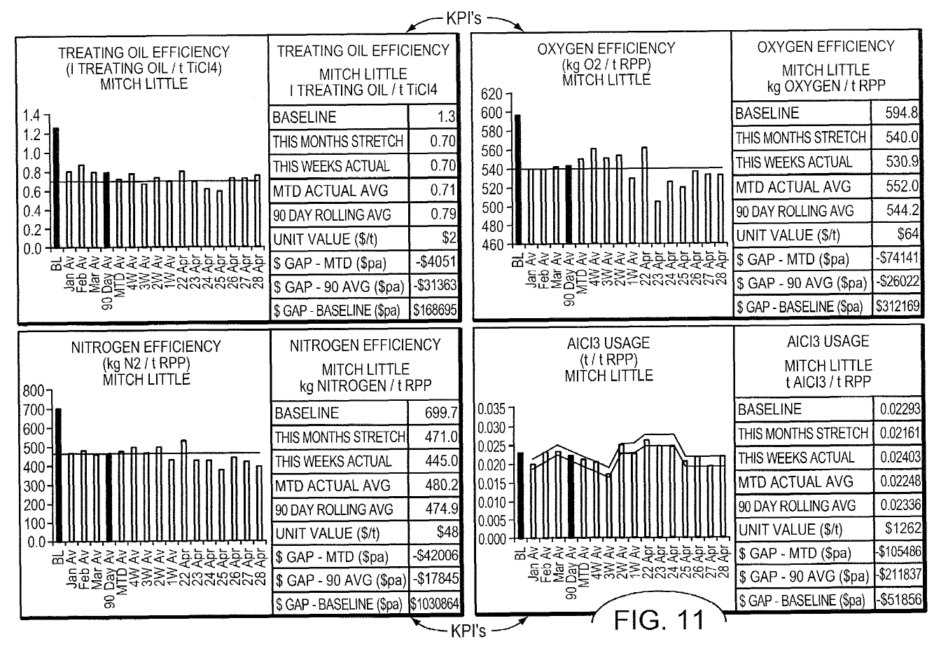

The process of implementing the organizational wiring pyramid of FIG. 9 requires a number of repeatable steps supported by both standard and specific methods and tools some elements of which are as follows:
1. Rigorous review of KPI's for overlaps and gaps to develop clear accountabilities.
2. Develop individual monthly KPI scorecards that extend from managers down to production supervisors (For example, a monthly KPI scorecard may be developed that is reviewed on a one-on-one basis each month. The managers, coordinators, team leaders, and other managers as appropriate may be involved. Typically actual results are compared to results forecast. Areas covered may include the risks, accidents, injuries, headcount, production quantities (if applicable) resource utilizations and financials.
3. Result Action Reviews (RAR's) may be conducted weekly. FIG. 10 illustrates an outline/flowchart that might be suitable for RAR'S. Here there are eight topics that are reviewed. First RESULTS are analyzed, Are the results as expected, did the “idea” work. Next ACTIONS are analyzed, did the person being reviewed (and their reports) complete the actions committed to. The FUTURE actions are planned or updated and new TARGETS are set. During such a review, priorities are updated or established if necessary, Resources allotted, communication paths determined. People are assigned tasks including a schedule. In addition short, say five minute, review summaries are generated. Such a summary may detail: highlights (successes, etc.); lowlights (problems, issues, problems, etc.); issues at hand; and priorities determined and made known.
4. Detailed KPI tracking FIGS., baseline, monthly, weekly and daily (FIG. 11). FIG. 11 illustrates KPI's for a number of activities where a baseline number 9a starting number) is recorded and monthly, weekly and even daily charts may be generated for comparison purposes. In FIG. 11, efficiencies of treating oil, oxygen, nitrogen and AlCl3 usage are detailed.

To make these elements of wiring standard, repeatable and sustainable, the RAR process is embedded in software and can be rolled up to the CEO level from the production level.

The constant review process combined with not unrealistic “stretch” targets acts as a self-reinforcing ratchet mechanism to drive up performance over time.

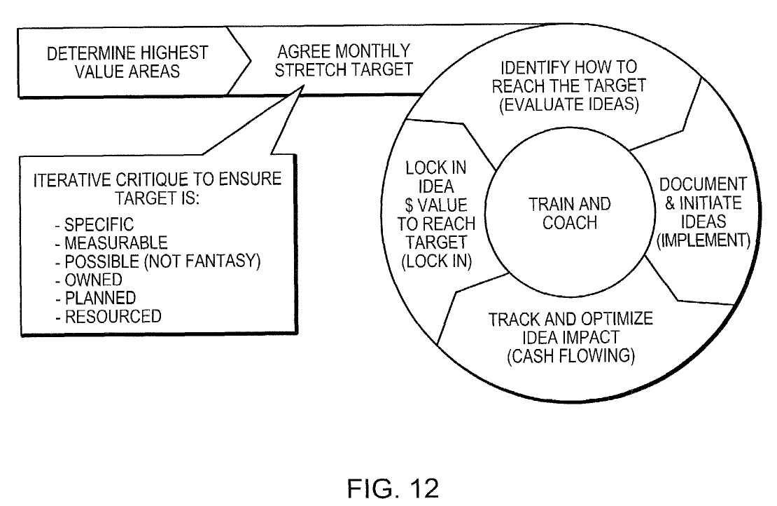

FIG. 12 illustrates the advantageous culture provide to a business by their embracing of the present invention. A culture is established with a performance focus and where continuous business improvement is created by setting these stretch targets combined with regular reviews. The center of the circle is “Train and Coach.”

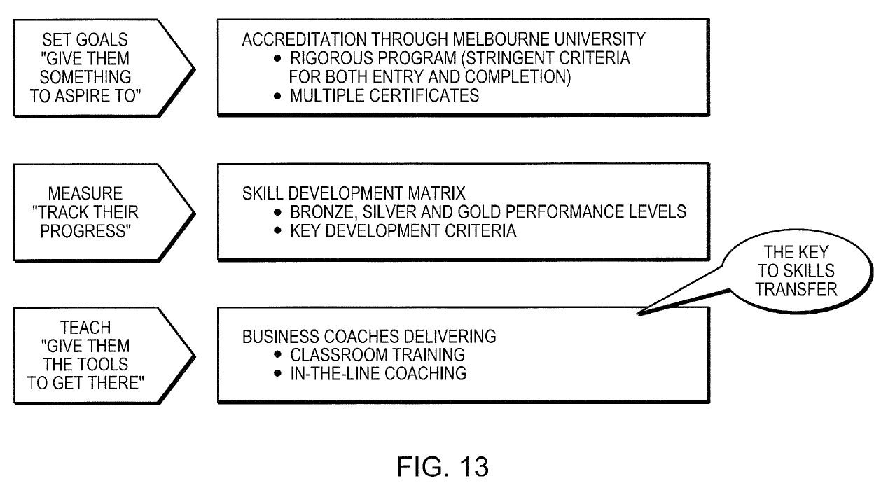

### Leadership and Coaching Schematic (FIG. 13

FIG. 13 illustrates using wiring and ideas as a training ground for developing people capabilities through in-the-line business coaches and. skills transference through formal education and coaching.

An important concept of the invention may require that the traditional management consulting process be avoided at all costs. The only professional staff involved in delivery of the invention are experienced “business coaches” whose role is to work directly with line management to develop the necessary operating skills and disciplines to implement the invention. Once implemented, continuous process improvement is sustainable without further professional service support.

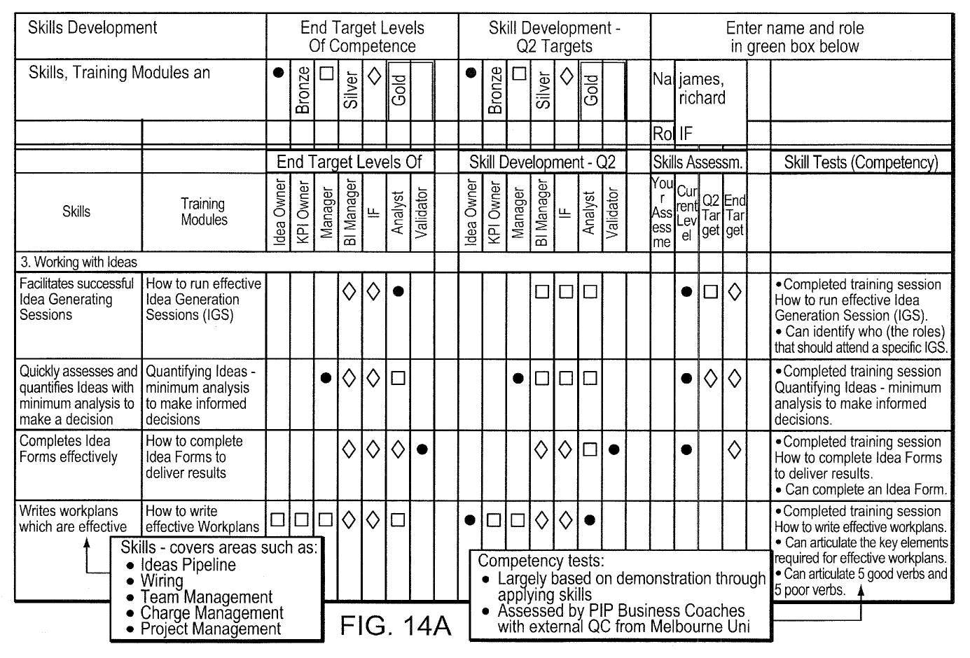

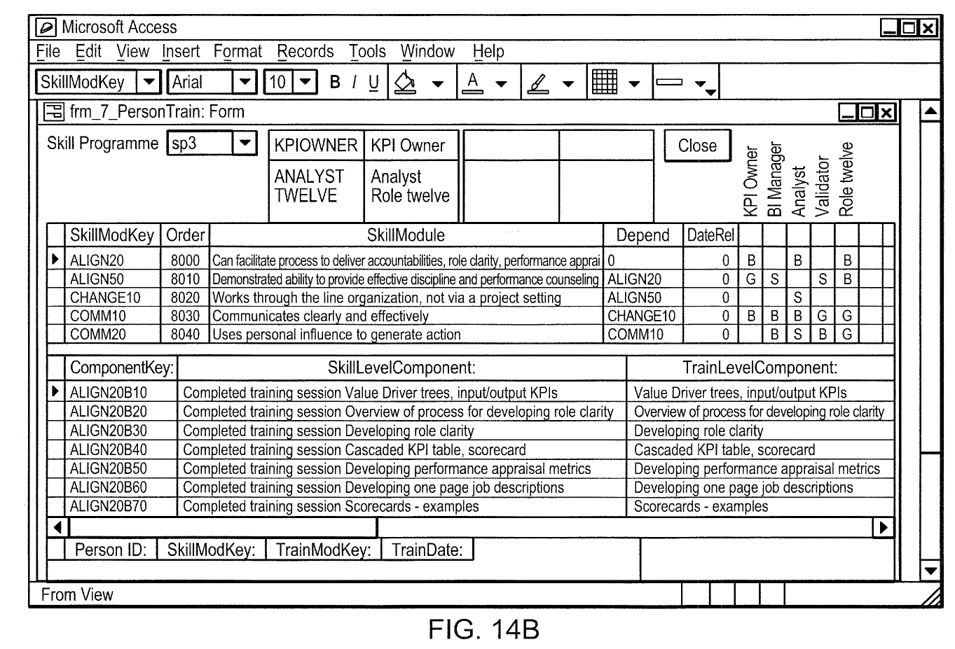

The skills transfer/development process is supported and delivered through a formal skills matrix and gap analysis tool embedded in software. FIG. 14A shows a skills matrix that lays out the training and target level of competence required for each key role in the line organization. It also tracks progress towards achieving target skill levels for each individual and group. It may comprise:

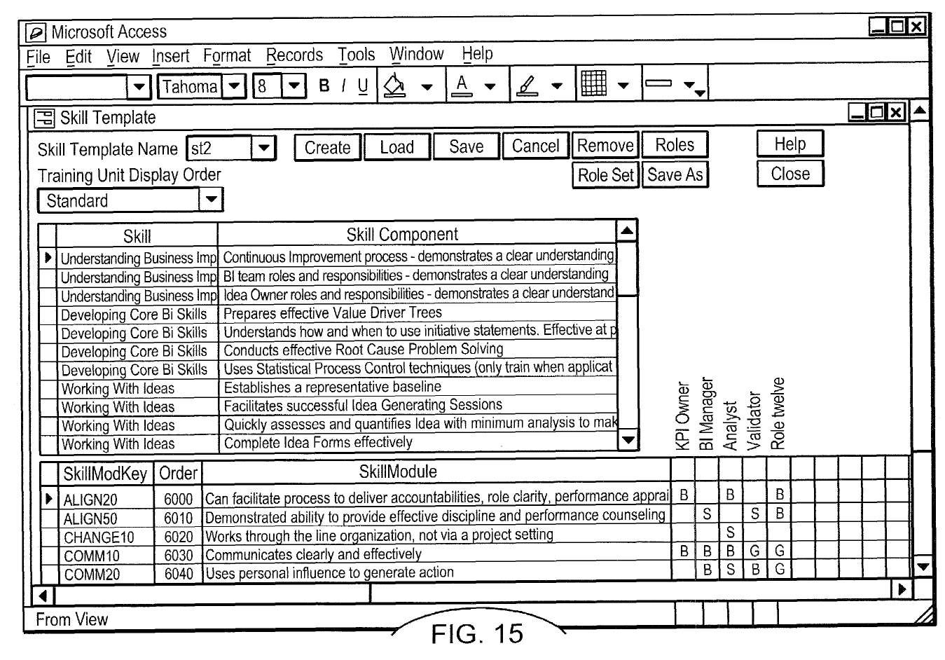

1. Skills Template Forms: The Skills Template enables selection of individual skills, roles and skill levels (FIG. 14B). One or more skill templates may be used to create a program. Examples may include a skills program template, a training template, a training course.
2. Training Template Forms: Skill templates can be merged to form a training template. The skills identified in the skill template expand into the training components for that skill. A training program is assembled from one or more training templates. The roles which have been assigned to attend each training component in the training program are read from the skill template.
3. Training Course: A Training Course is created from a Training Program. Once a course is started, sessions can be created by selecting the components for the session and completing the session by updating the training record with the attendees.
4. Training Record: For each skill, for each role, for each person the training record shows, the components required to reach the level; which of those components have been taken and which remain. FIG. 15 shows a template training record. Here various skills achieved and sessions completed may be recorded.

The further formalization of skills development and transfer is embodied in Partners In Performance (PIP) designed degrees and certificates in operations management developed in concert with the higher education institutions in Australia and elsewhere. A world wide university certification network may be developed as a logical extension of this initial program.

It should be understood that above-described embodiments are being presented herein as examples and that many variations and alternatives thereof are possible. Accordingly, the present invention should be viewed broadly as being defined only as set forth in the hereinafter appended claims.

What is claimed is:

1. A method for managing a business process, the method comprising the step of pipelining a continuous series of ideas, wherein the step of pipelining comprises the steps of:
identifying and evaluating the ideas;
implementing the ideas into the business process;
ensuring that results (cash) are flowing; and
locking in the ideas and tracking for sustainability.

2. The method of claim 1 further comprising the steps of:
endorsing the ideas before implementing;
first agreeing that targeted results were sufficient to continue implementing;
second agreeing that the results are working (cashflowing);
Third agreeing that the results justify locking in the idea, and after locking in the idea; and
auditing the results for continued sustainability.

3. The method of claim 1 wherein the step of identifying and evaluating comprises the steps of:
specifying issues, the source of the issues, and corresponding actions involved with each idea;
analyzing the benefits risks and rewards corresponding to each idea; and
syndicating each idea among stakeholders and owners of the idea.

4. The method of claim 3 wherein the step of analyzing comprises the steps of:
prioritizing the ideas;
developing mitigating or risk management strategies where needed;
developing a plan with identified personnel accountabilities to implement the ideas;
identifying key performance indicators to assess if the ideas are working; and
developing a tracking plan.

5. The method of claim 4 wherein the step of prioritizing the ideas comprises the steps of:
comparing the value and ease, including capital, risk, resource requirements, difficulty and duration to successfully implement, of implementing each idea; and therefrom listing those ideas from highest priority to lowest, the higher ones for direct input into the ideas pipeline for evaluation and implementation and the lower ones to wait until higher priority ideas allow the lower ones to be implemented.

6. The method of claim 1 wherein the step of implementing comprises the steps of:
proactively managing a detailed implementation plan for every idea, the proactive management including weekly idea owner reviews, reviews of critical path, problem solving implementation problems and barriers.

7. The method of claim 1 wherein the step of ensuring results were flowing further comprises the steps of:
validating the results;
adjusting the idea and its implementation steps to ensure it is working (cash flowing) and to optimize its value; and
identifying requirements for locking in the idea and assigning resources to complete these steps.

8. The method of claim 1 wherein the step of locking in comprises the steps of:
ensuring that all the steps required to lock in the idea and make the idea sustainable are completed and that stakeholders agree with the lock in.

9. A method for managing a business process, the method comprising the steps of:
pipelining ideas;
wiring the business for handling the pipelined ideas, wherein the step of wiring comprises the steps of:
determining an operating strategy for each stage of the business/process based on what is required to deliver the key performance indicators, KPI'S;
specifying in detail the operating disciplines required by each level of the organization in each area to ensure that the operating strategy is carried out;
ensuring razor sharp role clarity and accountability for each KPI by one individual and coaching and holding the KPI owner accountable for maintaining and improving results;
determining disciplines and skills required for effective sustaining the results including weekly reviews at each layer of the business of results (KPIs and Ideas) and actions (completed or not);
ensuring a continuous improvement process is in place including setting of stretch targets at each layer in the business on a monthly basis; and
visibly leading the people in the business to deliver KPI results and improve the businesss' wiring.

10. The method of claim 9 further comprising the steps of:
developing scorecards and KPI results charts for each KPI owner that are timely updated;
timely reviewing the scorecards and results charts with each KPI owner; and
determining actions based on the results and discussion in each review.

11. A method for managing a business, the method comprising the steps of:
pipelining ideas;
wiring the business for handling the pipelined ideas;
coaching the personnel involved to manage the results associated with their KPIs 1616
documenting training and competency records of the individuals involved with the ideas.
